(19) United States
(12) Patent Application Publication
(10) Pub. No.: US 2011/0300767 A1
(43) Pub. Date: Dec. 8, 2011

(54) Attaching proteinaceous microspheres to a variety of fabrics using ultrasound radiation

(75) Inventors: Aharon GEDANKEN, Givataim (IL); Ulyana Shimanovich, Givataim (IL); Ilana Perelshtein, Rishon Le Zion (IL)

(73) Assignee: BAR-ILAN UNIVERSITY, Ramat Gan (IL)

(21) Appl. No.: 13/154,855

(22) Filed: Jun. 7, 2011

Related U.S. Application Data
(63) Continuation-in-part of application No. 12/997,276, filed on Dec. 10, 2010.
(60) Provisional application No. 61/344,193, filed on Jun. 8, 2010.

(51) Int. Cl. B32B 5/22; B06B 1/20

(52) U.S. Cl. 442/123; 427/601; 442/59

(57) ABSTRACT

The present invention discloses a novel system for preparing fabrics with antibacterial properties by sonochemically impregnating the fabrics with proteinaceous microspheres loaded with antibiotic. Antibacterial fabrics are widely used for production of outdoor clothes, under-wear, bed-linen, bandages, etc.

### CROSS REFERENCES

This patent is a continuation-in-part of U.S. patent application Ser. No. 12/997,276, filed Dec. 10, 2010, now pending, and claims priority from U.S. Provisional Application No. 61/344,193, filed Jun. 8, 2010. Both of these applications are incorporated by reference.

### FIELD OF THE INVENTION

This patent pertains to a means and method for sonochemical coating of textiles with drug-loaded microspheres for antimicrobial fabrics.

### BACKGROUND OF THE INVENTION

The present invention relates to the attaching of different kinds of microspheres to a variety of fabrics using ultrasound radiation.

There have been some investigations dealing with binding proteins to different kinds of fabrics [Goodyear Tire & Rubber Co. Dec. 19, 1962 [Apr. 12, 1961], No. 47881/62; Agglutinated fibrous sheet materials. Harmon, C. Mar. 25, 1959 [Mar. 26, 1958], No. 10424/59; JP7268778 (A) Publication date: 1995-10-17 Inventor(s): Shimizu Yoshio, Takizawa Masahiro Applicant(s): Lion Corp; GB942586 (A) Publication date: 1963-11-27 Inventor(s): Applicant(s): Dow Corning; 555, 146. Tanks Duerden, A., and Imperial Chemical Industries Ltd. Aug. 29, 1940, No. 13602; Institut Textile De France. Feb. 17, 1959 [Feb. 28, 1958], No. 5461/59. Class 140. [Also in Group IV (c)]]. In those studies different techniques of binding proteins to textiles were employed. The methods include: infra-red heating, agglutination, using adhesive compounds which improves the bonding of the threads to rubbers and proteins, bonding protein or polysaccharides having organosiloxane side chains (which are responsible for binding) by dissolving or dispersing a polysaccharide or a protein (in water and/or alcohol) and applying the resultant treatment liquid to the textile. Polymeric microspheres were also attached to textiles, with or without cosmetic or pharmaceutical active molecules, by using agglutination properties of these polymers, or by using self-adhesive or thermo-adhesive polymeric microspheres. [US2005266092 (A1) Publication date: 2005-12-01 Inventor(s): Viladot Petit Josep-Liuis [ES], Caldero-Linnhoff Gabriela [ES], WO2005098125 (A1) Publication date: 2005-10-20 Inventor(s): Bartoli Cesare [IT] Applicant(s): Ind Bergamasca Rifrangenti S R [IT], Bartoli Cesare [IT]; DE10224984 (A1) Publication date: 2003-12-18 Inventor(s): Duris Tibor [DE], Mosbach Ralf [DE], Riethues Michael [DE], Renz Guenter [DE]; Jacob Dieter [DE] Applicant(s): BASF Ag [DE]; U.S. Pat. No. 6,562,737 (B1) Publication date: 2003-05-13 Inventor(s): Bohin Fabrice [FR], Dalbe Bernard [FR], Dumont Laurent [FR], Heilmann Jens [DE], Kaiser Uwe [DE], Pouchelon Alain [FR], Pusineri Christian [FR], Walz Joachim [DE] Applicant(s): Rhone Poulenc Chimie [FR]; WO9935327 (A2) Publication date: 1999-07-15 Inventor(s): Burns Alonzo M Jr, Chen Hao A, Zerebecki Nicholas, Patterson Charles Applicant(s): Mannington Mills [US]; US2003157295 (A1) Publication date: 2003-08-21 Inventor(s): Burns Alonzo M [US], Chen Hao A [US], Zerebecki Nicholas [US], Patterson Charles [US] Applicant(s): Burns Alonzo M, Chen Hao A, Zerebecki Nicholas, Patterson Charles]

Ultrasonic emulsification is a well-known process and occurs in biphasic systems. [Wagner, H. N., Sabistan, D. C., Maa' [symbol] e, J. G., Tow, D. E., Stern, H. S., New Engl. J. Med. 271 (1964) 377; Sche [symbol] el, U., Rhodes, B. A., Natarajan, T. K., Wagner, H. N., J. Nucl. Med. 13 (1972) 488; Rhodes, B. A., Croft, B. Y., Basics of Radiopharmacy, Mosby, St. Louis, Mo., 1978]. Emulsification is necessary for microcapsule formation. Micrometer sized gas- or liquid-filled microspheres can be produced from various kinds of proteins such as bovine serum albumin (BSA) [Suslick, K. S.; Grinstaff, M. W. J. Am. Chem. Soc. 1990, 112, 7807; Grinstaff, M. W.; Suslick, K. S. Polym. Prepr. 1991, 32, 255; Grinstaff, M. W.; Kolbeck, K. A.; Magin, R. L.; Suslick, K. S.; Webb, A.; Wilmes, L. J.; Wong, M.; Desai, N. P.; Sandford, P. A.; Soon-Shiong, P. Proc. Soc. Biomater. 1994, 20, 113], human serum albumin (HAS) [Suslick, K. S.; Grinstaff, M. W. Proc. Natl. Acad. Sci. U.S.A. 1991, 88, 7708], and hemoglobin (Hb) [Wong, M.; Suslick, K. S. Mater. Res. Soc. Symp. Proc. 1995, 372, 89]. Recently we have demonstrated that microspheres can be made of a polysaccharide such as chitosan. According to the mechanism of the sonochemical formation of protein microspheres (PM), the microspheres are formed by chemically cross-linking cysteine residues of the protein with HO₂ radical formed around a micron-sized gas bubble or a non-aqueous droplet. The chemical cross-linking is responsible for the formation of the microspheres and is a direct result of the chemical effects of the ultrasound radiation on an aqueous medium. We have demonstrated that proteins such as streptavidin or polyglutamic acid can also be spheridized by adjusting the pH. [S—S bonds are not required for the sonochemecial formation proteinaceous microspheres: the case of streptavidin. S. Avivi and A. Gedanken, Biochemical Journal 366, 705-707 (2002)]

Protein microspheres have a wide range of biomedical applications, including their use as echo contrast agents for sonography [Dose-dependent use of dobutamine to alter early diastolic filling in normal subjects. Vandenberg, B F, Stark, C A, Rumberger, J A. J. Am. Cardiol. 1988; 62:333-334], magnetic resonance-imaging contrast enhancement [In-vivo measurement of oxygen concentration using sonochemically synthesized microspheres. Liu, K J, Grinstaff, M W, Jiang, J, Suslick, K S, Swartz, H M, Wang, W. Biophys. J. 1994; 67:896-901; The measurement of temperature with electron paramagnetic resonance spectroscopy. Eckburg J J, Chato J C, Liu K J, Grinstaff, M W, Swartz H M. J. Biomech. Eng. 1996; 118:193-200; Sonochemically produced fluorocarbon microspheres: A new class of magnetic resonance imaging agent. Webb, A G, Wong, M, Kolbeck, K J, Magin, R L, Wilmes, L J, Suslick K S. J. Magn. Reson. Imaging. 1996; 6:675-683], and oxygen and drug delivery. [Protein microspheres as delivery systems. Wong, M, Suslick, K S. Abstracts of papers of the Am. Chem. Soc. 2000; 219: U7-U7; Intravenous targeted delivery of Taxol in protein microspheres. Desai, N P, Soon-Shiong, P, Grinstaff, M W, Yao, Z, Sandford, P A, Suslick, K S. Proc. Soc. Biomater. 1994; 207:91-MEDI]

The transmission of infectious disease agents in health-care facilities is an increasingly important concern to medical providers and the public.[1-4] The survival of microorganisms has occurred on textiles materials and plastics [3] and their transmission has been demonstrated as a result of surface contact with hands, fabrics, and hospital devices such as surgeons' gowns and nurses' clothing.[5-6] Currently, physical barriers to microorganisms rely on the use of disposable nonwoven garments, and these are widely employed in operating and emergency rooms. Until now there has been no practical way to provide an enhanced level of antimicrobial protection to health care providers who wear garments made of woven reusables. [7]

Effective biocidal materials for reusable clothing could find a place in hospitals, operating rooms, and other work-related work environments involving exposure to disease agents. A number of methods for incorporating antimicrobial functions into textiles materials have been developed elsewhere. [8-9] Agents used to date include quaternary ammonium salts,[10-11] metal ions,[9] and antibiotics.[12] Despite the variety of systems reported in the literature, most treated textiles lack durability in their antimicrobial function are scarcely effective against many microbes, or have a capacity that is nonregenerable and subject to rapid decline when used. The production of durable, biocide textiles materials has not been reported previously by using any of these approaches.

Hence the present invention, which satisfies a long-felt need for a means and method of producing fabrics with effective, durable biocidal activity for reusable clothing.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents staining levels (K/S) of cotton and polyester fabrics coated with BSA and casein microspheres, dyed with Coomassie Brilliant Blue G after washing in a Rotawash machine (60 min, 40° C., 40 rpm): PES=PM coated on polyester fabric, Co=PM coated on cotton fabric, PES-GA=PM coated on polyester fabric treated with GA, Co-GA=PM coated on cotton fabric treated with GA;

FIG. 2A-D presents Apo-Tome images of fibers: a—a pristine cotton fiber, b—a cotton fiber coated with BSA microspheres, c—a pristine polyester fiber, d—polyester fibers coated with BSA spheres;

FIG. 3 presents the change in amount of BSA microspheres (as a percentage) bonded to fabrics vs. time; and

FIG. 4A-D presents zones of inhibition of S. aureus and E. coli on agar plates as a result of: a—Tetracycline freed from microspheres attached to cotton fabric, b—Tetracycline freed from microspheres attached to polyester fabric. In the images, the numeral 1 refers to cotton fabric, the numeral 2 to polyester fabric, and the numeral 3 to a commercial tablet of Tetracycline.

### SUMMARY OF THE INVENTION

The present invention discloses a method useful for ultrasonically impregnating textiles with microspheres which may or may not be loaded with an effective measure of at least one predefined agent. The method comprising steps of preparing an aqueous solution containing a protein; layering an organic solvent above said aqueous solution; immersing a textile in said aqueous solution; adding a predetermined agent to said aqueous solution; irradiating said mixture with high-intensity ultrasonic power; controlling the temperature of said mixture during said irradiation; and washing said textile to remove the residue of unbound microspheres and pristine protein molecules. The reaction creating the microspheres and impregnating the fabric with them occurs in a two-phase system during step as defined above.

The present invention also discloses the method as defined above, wherein the reaction occurs in a time shorter than the stability time of the said predetermined agent.

The present invention also discloses the method as defined above, wherein the reaction creating the microspheres and impregnating the fabric with them occurs during a single step, as defined above

The present invention also discloses the method as defined above, wherein the protein is one member of a group consisting of bovine serum albumin, bovine fraction v (BSA); or fluorescein isothiocyanate-conjugated bovine serum albumin (f-BSA); and casein sodium salt (casein).

The present invention also discloses the method as defined above, wherein the concentration of BSA in the solution is 5% w/v.

The present invention also discloses the method as defined above, wherein said organic solvent is one of 98% dodecane or 97% mesitylene or an oil such as, but not limited to, cotton, soya or rapeseed oil.

The present invention also discloses the method as defined above, wherein said predetermined agent is Tetracycline.

The present invention also discloses the method as defined above, wherein tetracycline is added in a concentration of 5.4×10⁻³ M.

The present invention also discloses the method as defined above, wherein no predetermined agent is added to the mixture.

The present invention also discloses the method as defined above, wherein said step of irradiating said mixture is carried out by at least one means selected from a group consisting of (a) an ultrasonic horn; (b) ultrasonic waves at a frequency of approximately 20 kHz; (c) ultrasonic waves at a power of approximately 58 W/cm² for dodecane; (d) ultrasonic waves at a power of approximately 150 W/cm² for mesitylene; or any combination thereof.

The present invention also discloses the method as defined above, wherein said step of irradiating said mixture is carried out for 3 minutes.

The present invention also discloses the method as defined above, wherein said step of irradiating said mixture is carried out at approximately 22° C.

The present invention also discloses the method as defined above, wherein said textile is dyed with Coomassie Brilliant Blue G (Acid Blue 90, C.I.) after washing.

The present invention also discloses the method as defined above, wherein said textile composite contains between 17% and 23% of the total of said antibiotic added to said mixture, encapsulated in PMs attached to said fabric.

The present invention also discloses the method as defined above, wherein drug-loaded PMs are between 680 nm and 8 μm in diameter.

The present invention also discloses the method as defined above, wherein said PMs remained bonded to said fabrics for as long as 9 months.

The present invention also discloses the method as defined above, wherein said PMs remained bonded to said fabrics after laundering.

The present invention also discloses the method as defined above, wherein the textiles are imparted with improved properties by means of ultrasonic irradiation of said textiles in said mixture, thereby attaining uniform impregnation of said properties in said textiles.

The present invention also discloses the method as defined above, wherein the textiles are imparted with biocidal properties, thereby attaining biocidal activity.

The present invention also discloses the method as defined above, wherein the textiles are imparted with increased dye affinity, thereby attaining brighter color when dyed.

The present invention also discloses the method as defined above, wherein the textiles are imparted with color, thereby attaining colored textiles.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing textiles impregnated with tetracycline-loaded proteinaceous microspheres.

In the following detailed descriptions, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘sonochemical irradiation’ hereinafter refers to exposure to sonic power, generally in the power ultrasonic range of frequencies.

The term ‘sonochemistry’ refers to the study or use of sonochemical irradiation.

The term ‘microspheres’ hereinafter refers to particles of size ranging from approximately 10 micrometers to approximately 10 nanometers.

The term ‘agent-loaded microspheres’ hereinafter refers to said particles or a liquid when a predefined agent is encapsulated with them.

The term ‘pristine microspheres’ hereinafter refers to said particles when they contain no such predefined agent.

The term ‘antibiotic’ hereinafter refers to any predefined agent. In the following when Tetracycline is used specifically, it is used in exemplary fashion and can be replaced by other predefined agents as will be obvious to one skilled in the art.

The term ‘plurality’ refers hereinafter to any positive integer e.g, 1, 5, or 10.

The term ‘protein’ hereinafter refers to a 5% w/v solution of bovine serum albumin (BSA). In the following, when BSA is used specifically, it is used in exemplary fashion and can be replaced by f-BSA or casein or by other proteins as will be obvious to one skilled in the art.

The term ‘organic solvent’ hereinafter refers dodecane. In the following, when dodecane is used specifically, it is used in exemplary fashion and can be replaced by mesitylene or by an oil such as, but not limited to, cotton, soya or rapeseed oil or by other organic oils and solvents as will be obvious to one skilled in the art.

It is within provision of the instant invention to offer a new process for preparation of textiles impregnated with agent-loaded proteinaceous microspheres. The sonochemical method is applied for the deposition of antibiotic-loaded proteinaceous microspheres on textile materials to impart to them excellent antimicrobial activity. A comparison of the suggested tetracycline-loaded proteinaceous microsphere-textile nanocomposite to other methods of imparting antimicrobial activity shows a clear advantage of the ultrasound radiation over all other available methods as will be described below.

We have demonstrated that sonochemical irradiation is a suitable method for synthesis of microspheres, and their deposition/insertion on and into textiles. One of the many advantages demonstrated for sonochemistry is that a homogeneous dispersion of the microspheres on the surface of the textile is achieved in one step. In this step the microspheres of the desired products are formed and accelerated onto and into the surface or body of the textile via micro jets or shock waves that are created when a sonochemically produced bubble collapses near a solid's surface.

Using sonochemical radiation, we have succeeded in attaching a drug loaded proteinaceous (BSA and/or casein) microsphere to cotton and polyester fabrics by a one-step process that lasts a few minutes, the time needed for the creation of the microbubbles and their resulting microspheres. We have found that if during the sonication time a drug or a dye and a piece of fabric are added to the precursor mixture containing an aqueous solution of a protein plus an over layering organic solvent, the drug or dye will be encapsulated inside the microspheres and the spheres will be bonded to the fabric. Different drugs have been successfully encapsulated in the microspheres. The sizes of microspheres anchored to cotton and polyester fabrics are different: 1300 nm on cotton and 600 nm on polyester. This could be explained as due to the difference in the chemical structure of the fabrics. The drug-coated fabrics are therefore suggested to be used as antibacterial fabrics. The drug-coated bandages revealed an antibacterial activity stronger than that of a commercial TTCL tablet.

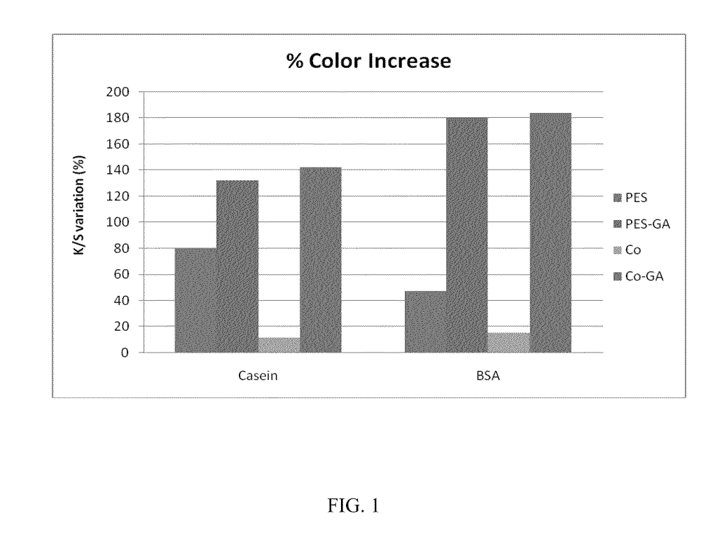

The PMs can be used to improve dye affinity. Fabrics coated with pristing PMs were dyed and washed under the usual testing conditions in a Rotawash machine (60 min, 40° C., 40 rpm) in order to determine the effect of the proteinaceous microspheres on dye affinity. The results show that proteinaceous microspheres bound to cotton or polyester increased dye affinity, especially for acid dyes such as: Coomassie Brilliant Blue G. The gluteraldehyde (GA) cross-linked microspheres bound to fabrics showed an increase in the dye affinity, as compared to PM coated fabrics without GA. This results from a better protein fixation on the fabrics' surfaces when GA is used. Proteinaceous microspheres on the fabrics were measured by the modified Lowry method [Indigo backstaining during cellulase washing. Cavaco-Paulo, A, Morgado, J, Almeida, L, Kilburn, D. Textile Res J. 1998; 68:398-401]. The results of the K/S values (color staining levels) at 620 nm are presented in FIG. 1.

The stability of bonded spheres under ambient conditions of using and wearing the textiles was measured by using dyeing and washing under tests (modified Lowry method). By this technique we have measured the bond strength between proteins and fabrics. The results show that proteinaceous microspheres bound to polyester remain bound to the fabric even after repeated washings in a washing machine. In regard to cotton, only a small amount of PMs were found on the fiber surface after repeated washings. Using glutaraldehyde will keep the microspheres attached to cotton, as well as polyester, even after repeated washings. It is therefore suggested these coated bandages can be used either for one-time application or for repeated use. Under storage conditions, the BSA PMs were found to be stable for more than 9 months on cotton and polyester surfaces.

The use of the sonochemical method helps to achieve all the principal requirements of the antimicrobial textile coated with nanomaterials: small particle size, regular shape, and homogeneous distribution of the proteinaceous microspheres on the fabrics. Amongst the advantages of using ultrasound over other methods is that ultrasonic shockwaves effectively blast the proteinaceous microspheres onto a fabric's surface at such speed that it causes local melting of the substrate, guaranteeing firm embedding of the microspheres within the textile fibers. Textiles sonochemically impregnated with drug-loaded proteinaceous microspheres display outstanding antimicrobial activity in the case of both gram-positive and gram-negative bacteria.

Experimental procedures were developed as follows for testing and evaluation purposes. Other routes will be obvious to one skilled in the art, and the following is provided only by way of example.

According to one embodiment of the invention, which produces proteinaceous microspheres loaded with antibiotic, the textile preparation was as follows:
1. A textile sample (such as a cotton square of approximately 5 cm×5 cm) is placed in a solution of BSA in water.
2. Dodecane is layered above the BSA solution.
3. Tetracycline is added to the BSA-water mixture, until a 5.4×10⁻³M solution is formed.
4. Quickly thereafter the solution is irradiated for 3 minutes with a high intensity ultrasonic horn (Ti-horn, 20 kHz, 58 W/cm² at 30% amplitude).
5. During irradiation, the temperature of the solution is kept constant at 22° C. using an ice bath.
6. The textile is washed thoroughly with water to remove the residue of unbound microspheres and pristine protein molecules and is dried in air.

According to another embodiment of the invention, which produces pristine microspheres, the textile preparation was as follows:
1. A textile sample (such as a cotton square of approximately 5 cm×5 cm) is placed in a solution of f-BSA in water.
2. Dodecane is layered above the f-BSA solution.
3. Quickly thereafter the solution is irradiated for 3 minutes with a high intensity ultrasonic horn (Ti-horn, 20 kHz, 58 W/cm² at 30% amplitude).
4. During irradiation, the temperature of the solution is kept constant at 22° C. using an ice bath.
5. The textile is washed thoroughly with water to remove the residue of unbound microspheres and pristine protein molecules and is dried in air.

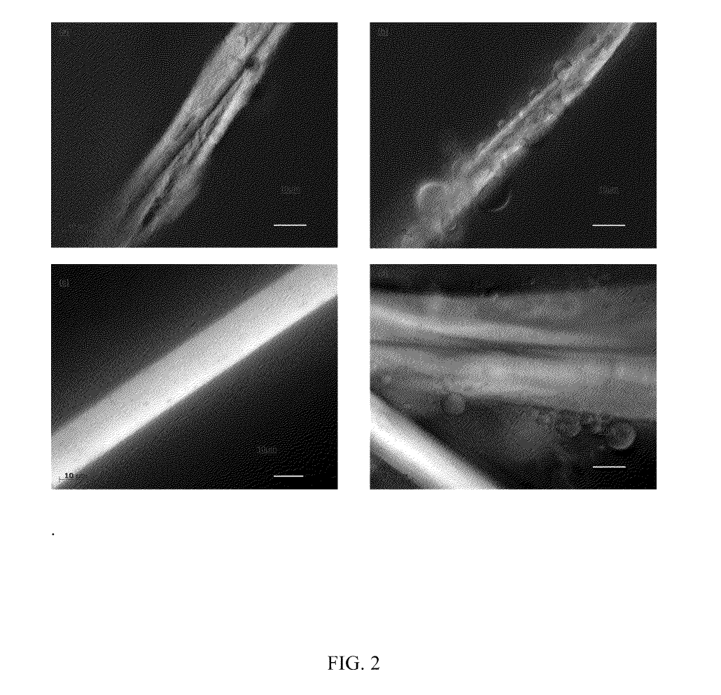

The morphology of the cotton and polyester bandages coated with TTCL-loaded BSA/casein microspheres was determined by light microscopy. For both proteins (BSA and casein) the morphology of the attached PMs was found to be similar. FIG. 2(a) presents the image of an uncoated yarn of cotton. The fibrous nature of the yarn is clearly observed. In FIG. 2(b) we observe many microspheres attached to the cotton fiber. FIG. 2(c) and FIG. 2(d) show an uncoated polyester fiber and a coated polyester fiber, respectively. Similar results are observed for coating cotton and polyester bandages with casein microspheres encapsulated with a drug.

The efficiency of the sonochemical method in the creation and attachment of drug-loaded microspheres to cotton and polyester fabrics was studied using UV spectrophotometric measurements. The sonochemistry did not destroy the TTCL, as evidenced by the very small changes in the TTCL concentration (2-3%) that occur during the sonication of an identical precursor solution sonicated for the same time in the absence of the BSA/casein protein. No residues of the antibiotic were found in the excess dodecane (the upper phase).

In order to find the optimal concentration of the TTCL in the PMs, the preparation of coated fabrics was repeated by using different concentrations of the drug in the precursor solution while the protein concentration remained constant. The TTCL-loading studies showed that the optimal TTCL concentration in the precursor solution for microsphere attachment to cotton and polyester fabrics is 5.4×10⁻³ M. Using this concentration led to the attachment to the fabric of PMs containing the maximum amount of TTCL. Although the percentage of the drug (TTCL in PMs) increased with the increase in the concentration of the TTCL in the original solution, the total amount of TTCL in PMs attached to the fabric a reached a maximum when the concentration of the TTCL was 5.4×10⁻³ M; the percentage of the drug in the microspheres attached to the fabric's surface decreased with further increase of its concentration in the precursor solution. Reaching such a maximum can be explained as follows. The organic solvent is the major liquid to be found inside the newly formed microsphere. The solubility of TTCL in dodecane is limited; saturation is obtained when this limit is reached. Although some water can also be found in the microsphere its amount is small and can't add to the amount of encapsulated TTCL.

The concentration of TTCL on the fabrics was found as follows. The results obtained from the long heating process (4 days at 50° C.) were: 26.9% of TTCL was found on the cotton fabric and 31.8% of TTCL was found on the polyester fabric. These amounts include not only the TTCL encapsulated in the microspheres but also the amount of free TTCL directly adsorbed to the cotton and polyester bandages. The amount of TTCL directly adsorbed to cotton and polyester bandages was determined by soaking the coated fabric in water for 24 hours. The amount of TTCL removed from the bandages by soaking was determined in a Carry 100 spectrophotometer by UV absorption at 366 nm. Only 7.5% of TTCL was directly adsorbed to the cotton bandage and 11.4% of TTCL was adsorbed to polyester bandage.

To summarize the results and to find the exact amount of TTCL inside the microspheres attached to fabrics, we subtract the amount of TTCL directly adsorbed to fabrics from the total amount of TTCL which was found on the surface of fabrics. The same calculation was repeated after laundering the coated fabrics at the above-mentioned conditions. The results of calculation are presented in Table 1, which describes the calculation of amount (%) of TTCL encapsulated in PMs attached to the surface of fabrics. Loss of TTCL during the “laundering process” was determined by measuring the amount of TTCL which remain in the laundering solution after the laundering process. Both proteins BSA and casein showed similar results.

TABLE 1
Calculation of amount (%) of TTCL encapsulated in PMs attached to the surface of fabrics.

| | Total | | TTCL | TTCL directly | TTCL encapsulated | |
|---|---|---|---|---|---|---|
| | amount of | TTCL | encapsulated | adsorbed to | in PMs attached to | |
| | TTCL on | directly | in PMs | fabric after | fabric after | Loss of TTCL in |
| | surface of | adsorbed | attached to | “laundering | “laundering | “laundering” |
| Type of | fabric | to fabric | fabric | test” | test” | process |
| fabric | (%) | (%) | (%) | (%) | (%) | (%) |
| Cotton | 26.9 | 7.5 | 19.4 ± 2 | 3.7 | 17.6 ± 1.8 | 5.6 |
| Polyester | 31.8 | 11.4 | 20.4 ± 2 | 5.1 | 18.9 ± 1.8 | 7.8 |

These results point out that the loss of TTCL in this “laundering” process is 5.6% and 7.8% for the cotton and polyester, respectively. If we take into account that most of the removed TTCL is pristine TTCL, we can conclude that the microspheres are strongly bonded to these fabrics and perhaps can sustain a few machine washing cycles. Moreover, we have conducted the following control experiment. The adsorption of the TTCL loaded spheres (PMs with TTCL drug inside) to the surface of fabrics was studied without sonication. The pieces of cotton and polyester fabrics were incubated with the solution of TTCL loaded in PMs for 24 hours, and then washed several times with distilled water. Drug loaded PMs were not found attached to the fabrics' surfaces and only ˜2.6-3% of the TTCL was directly adsorbed to the surface of the fabrics. The results indicate that drug loaded PMs can be attached to the fabrics only when ultrasonic radiation is applied.

We have also examined the amount of protein attached to the textiles by spectrophotometric analysis (at 280 nm). First, the amount of protein (BSA or casein) left in the aqueous solution after sonication was subtracted from the total amount of protein introduced into the aqueous solution. The results indicate that the total amount of protein converted to microspheres is ˜87% for cotton and 89% in the case of polyester fabric in the reaction cell, which is composed of PM bonded and non-bonded to the fabric. To determine the amount of protein bonded to the coated fabrics, we placed them in water in a glass vial and heated the solution for 4 days at 45-50° C. Heating the solution destroyed completely the microspheres in the solution. The results showed that 34.8% of the PM of BSA and 47.3% of PM of casein protein were anchored to the polyester fabric, and 43.5% of PM of BSA and 31.6% PM of casein were attached to the cotton fabric.

It is worth noting that when four pieces of 5×5 cm cotton or four pieces of polyester bandages were sonicated with the precursor solution, all four pieces were coated with PMs and the amount of protein on the surface of each piece of fabric was found to be ˜20-22%. Thus, we found that a maximum amount of four bandages could be coated simultaneously in our 50 mL sonication cell.

The average sizes and the electrical charges of the PMs formed in the presence of cotton and polyester fabrics in the reaction cell were examined by DLS measurements. The average size and the electrical charge of TTCL loaded in BSA are 1282 nm and −15.7 mV, respectively. When pristine BSA or casein proteins were sonicated the DLS results yielded spheres with an average size of 2.34 μm for BSA PMs and 2.6 μm for casein PMs, and an electrical charge of −35 mV was measured for both types of microspheres. The size and the electrical charge difference between pristine PMs and drug loaded PMs could be explained by influence of the TTCL on formation of the microspheres. The electrical charge was decreased due to the presence of TTCL molecules on the outer surface of the microspheres. The next step was to check the influence of each type of fabric on the size and electrical charge of the created microspheres. The average size distribution of the spheres formed in the reaction cell with a piece of cotton fabric and a piece of polyester fabric are 1328 nm and 680 nm, respectively. The electrical charges of the PMs formed in the reaction cell with a piece of cotton fabric and a piece of polyester fabric are −13.1 mV and −8.16 mV, respectively. While the cotton coating exhibits PMs that are very similar in size and electrical charge to regular PM prepared without a fabric in the sonication cell, the size and the electrical charge are drastically reduced for the PMs anchored to the polyester fabric. These dramatic changes in size on the two fabrics were detected for the BSA as well as the casein. A possible explanation is that a higher concentration of PMs was found on the polyester fabric due to the better bonding of the protein to the polyester, which forms many centers around which the polymerization continues. The many seeds distributed upon the fabric continue to grow, and since the amount of protein is spread over a larger amount of seeds, smaller PMs are formed. The decrease in electrical charge from −15.7 mV (TTCL loaded PMs formed without presence of polyester in the reaction cell) to −8.16 mV could be explained by the more important role of the TTCL molecules on the smaller spheres formed on the polyester fabric leading to a larger decrease of the −35 mV detected for the bare PMs.

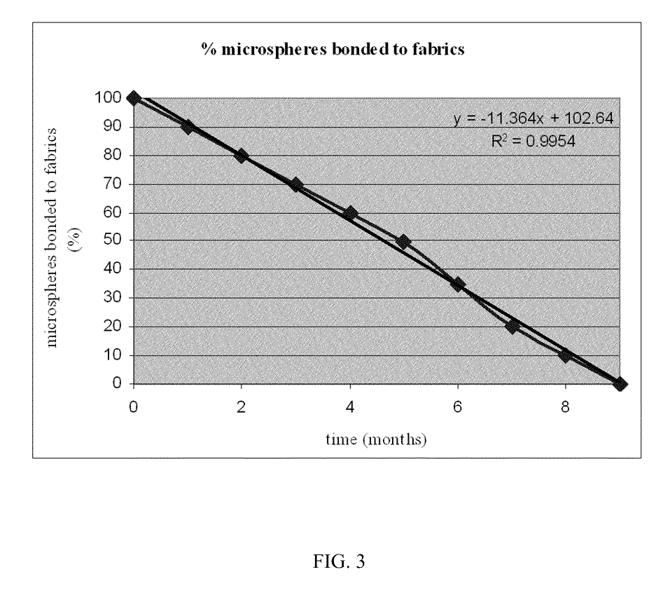

The stability over time of microspheres bonded to cotton and polyester bandages was also checked. Pieces of coated bandages (5×5 cm) were placed in a closed vial and checked periodically by light microscopy. The vial was kept at the ambient conditions of the laboratory. After three months only ˜70% of the microspheres remain bonded to the fabrics; the remaining 30% were destroyed. After five months ˜50% of the spheres were destroyed and 50% remained bonded to bandages. After seven months only ˜20% of the spheres remain on the bandages. Studies of the microsphere coating of the fabrics shows the linear relationship between the amounts of microspheres bonded to fabrics vs. time (FIG. 3). The percentage of the bonded spheres decreases with time.

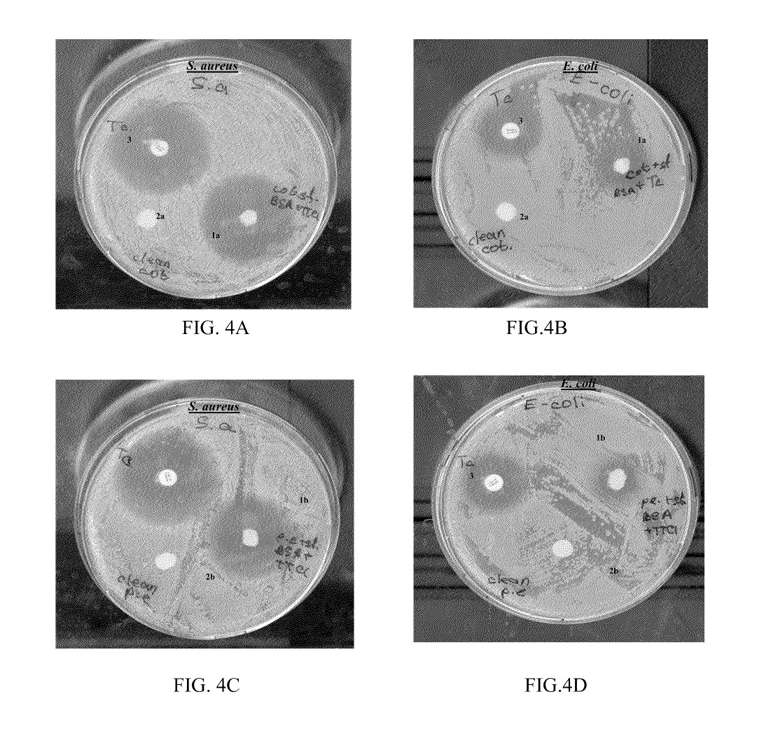

The antimicrobial activity of the TTCL loaded in BSA and casein microspheres attached to cotton and polyester bandages was tested on two bacterial strains (Staphylococcus aureus and Escherichia coli) that are sensitive to tetracycline. The results are shown in FIG. 4 and summarized in Table 2, which defines the inhibition zones for PMs (TTCL loaded PMs) coated fabrics and commercial tablet of Tetracycline. The antibacterial activity was measured for coated fabrics after “laundering” process. Both proteins BSA and casein showed similar results.

TABLE 2
The inhibition zones for PMs (TTCL loaded PMs) coated fabrics and
commercial tablet of Tetracycline.

| | | Zone of | Zone of |
|---|---|---|---|
| | Amount of | inhibition | inhibition |
| | TTCL | for S. aureus | for E. coli |
| Type of material | (μg) | (mm) | (mm) |
| Commercial Tablet of TTCL | 30 | 27 | 19 |
| Cotton fabric coated with TTCL | 12 | 27 | 18 |
| loaded PMs | | | |
| Polyester fabric coated with | 12 | 26.5 | 17 |
| TTCL loaded PMs | | | |
| Clean Cotton fabric | 0 | 0 | 0 |
| Clean Polyester fabric | 0 | 0 | 0 |

Coated bandages with microspheres loaded with TTCL have shown an inhibition zone (see numeral 2 in FIG. 4A-D) similar to inhibition zone of a commercial tablet of TTCL (see numeral 3 in FIG. 4A-D). The inhibition zones for cotton: For the S. aureus, 27 mm for the commercial tablet; the same size zone was observed also for the PM. For the E. coli: 19 mm for the commercial tablet, 18 mm for the PM. The inhibition zones for coated polyester: For the S. aureus, 27 mm for commercial tablet of TTCL and 26.5 mm for PM; for E. coli 19 mm for the commercial TTCL tablet and 17 mm for the PM. The difference in inhibition zones for the commercial tablet of TTCL and for PM coated cotton and polyester fabrics is due to the difference in the amounts of TTCL in the commercial tablet and inside the microspheres attached to the surface of fabrics which are 30 μg and ˜12 μg, respectively.

If we take into account these quantities, the PM coated textiles show a stronger killing effect for these two bacterial strains than the commercial TTCL tablet. The results of antibacterial tests are presented in FIG. 3.

It seems that the TTCL trapped in the microspheres attached to the surface of cotton and polyester fabrics and released to the medium is as active as the TTCL freed from the commercial tablet. Nevertheless, the “inhibition zone” results indicate that the encapsulated TTCL “antibacterial” effect is superior to that of the tablet since 1/3 of the amount of TTCL in the tablet is needed to reach the same antimicrobial activity as that of the commercial TTCL. It is worth mentioning that the TTCL is released in a fast mode due to the protease's activity.

The sonochemically treated bandages of cotton and polyester coated with microspheres loaded with TTCLs were found to be active as antimicrobial agents.

1. A method useful for ultrasonically impregnating textiles with microspheres which may or may not be loaded with an effective measure of at least one predefined agent, said method comprising steps of
a. preparing an aqueous solution containing a protein;
b. layering an organic solvent above said aqueous solution;
c. immersing a textile in said aqueous solution;
d. adding a predetermined agent to said aqueous solution;
e. irradiating said mixture with high-intensity ultrasonic power;
f. controlling the temperature of said mixture during said irradiation; and,
g. washing said textile to remove the residue of unbound microspheres and pristine protein molecules;
wherein the reaction creating the microspheres and impregnating the fabric with them occurs in a two-phase system during step e.

2. The method of claim 1 wherein the reaction occurs in a time shorter than the stability time of the said predetermined agent.

3. The method of claim 1 wherein the reaction creating the microspheres and impregnating the fabric with them occurs during a single step, step e of claim 1.

4. The method of claim 1 wherein said protein is one member of a group consisting of bovine serum albumin, bovine fraction v (BSA); or fluorescein isothiocyanate-conjugated bovine serum albumin (f-BSA); and casein sodium salt (casein).

5. The method of claim 1 wherein the concentration of BSA in the solution is 5% w/v.

6. The method of claim 1 wherein said organic solvent is one of 98% dodecane or 97% mesitylene or an oil such as, but not limited to, cotton, soya or rapeseed oil.

7. The method of claim 1 wherein said predetermined agent is Tetracycline.

8. The method of claim 1 wherein tetracycline is added in a concentration of 5.4×10⁻³ M.

9. The method of claim 1 wherein no predetermined agent is added to the mixture.

10. The method of claim 1 wherein said step of irradiating said mixture is carried out by at least one means selected from a group consisting of (a) an ultrasonic horn; (b) ultrasonic waves at a frequency of approximately 20 kHz; (c) ultrasonic waves at a power of approximately 58 W/cm² for dodecane; (d) ultrasonic waves at a power of approximately 150 W/cm² for mesitylene; or any combination thereof.

11. The method of claim 1 wherein said step of irradiating said mixture is carried out for 3 minutes.

12. The method of claim 1 wherein said step of irradiating said mixture is carried out at approximately 22° C.

13. The method of claim 1 wherein said textile is dyed with Coomassie Brilliant Blue G (Acid Blue 90, C.I.) after washing.

14. The method of claim 1 wherein said textile composite contains between 17% and 23% of the total of said antibiotic added to said mixture, encapsulated in PMs attached to said fabric.

15. The method of claim 1 wherein drug-loaded PMs are between 680 nm and 8 μm in diameter.

16. The method of claim 1 wherein said PMs remained bonded to said fabrics for as long as 9 months.

17. The method of claim 1 wherein said PMs remained bonded to said fabrics after laundering.

18. Textiles imparted with improved properties by means of ultrasonic irradiation of said textiles in said mixture, thereby attaining uniform impregnation of said properties in said textiles.

19. The textiles of claim 18 imparted with biocidal properties, thereby attaining biocidal activity.

20. The textiles of claim 18 imparted with increased dye affinity, thereby attaining brighter color when dyed.

21. The textiles of claim 18 imparted with color, thereby attaining colored textiles.

22. The textiles of claim 18, wherein said textiles are prepared by means of:
a. preparing an aqueous solution containing a protein;
b. layering an organic solvent above said aqueous solution
c. immersing a textile in said aqueous solution;
d. adding a predetermined agent to said aqueous solution;
e. irradiating said mixture with high-intensity ultrasonic power
f. controlling the temperature of said mixture during said irradiation; and,
g. washing said textile to remove the residue of unbound microspheres and pristine protein molecules;
wherein the reaction creating the microspheres and impregnating the fabric with them occurs in a two-phase system during step e.

23. The method of claim 22 wherein the reaction occurs in a time shorter than the stability time of the said predetermined agent.

24. The textiles of claim 22 wherein the reaction creating the microspheres and impregnating the fabric with them occurs during a single step, step e of claim 1.

25. The textiles of claim 22 wherein said protein is one member of a group consisting of BSA; f-BSA and casein.

26. The textiles of claim 22 wherein the concentration of BSA in the solution is 5% w/v.

27. The textiles of claim 22 wherein said organic solvent is one of 98% dodecane or 97% mesitylene or an oil such as, but not limited to, cotton, soya or rapeseed oil.

28. The textiles of claim 22 wherein said predetermined agent is Tetracycline.

29. The textiles of claim 22 wherein tetracycline is added in a concentration of 5.4×10⁻³ M.

30. The textiles of claim 22 wherein no predetermined agent is added to the mixture.

31. The textiles of claim 22 wherein said step of irradiating said mixture is carried out by at least one means selected from a group consisting of (a) an ultrasonic horn; (b) ultrasonic waves at a frequency of approximately 20 kHz; (c) ultrasonic waves at a power of approximately 58 W/cm² for dodecane; (d) ultrasonic waves at a power of approximately 150 W/cm² for or an oil such as, but not limited to, cotton, soya or rapeseed oil; or any combination thereof.

32. The textiles of claim 22 wherein said step of irradiating said mixture is carried out for 3 minutes.

33. The textiles of claim 22 wherein said step of irradiating said mixture is carried out at approximately 22° C.

34. The textiles of claim 22 wherein said textile is dyed with Coomassie Brilliant Blue G (Acid Blue 90, C.I.) after washing.

35. The textiles of claim 22 wherein said textile composite contains between 17% and 23% of the total of said antibiotic added to said mixture, encapsulated in PMs attached to said fabric.

36. The textiles of claim 22 wherein drug-loaded PMs are between 680 nm and 8 μm in diameter.

37. The textiles of claim 22 wherein said PMs remained bonded to said fabrics for as long as 9 months.

38. The textiles of claim 22 wherein said PMs remained bonded to said fabrics after laundering.
